(19) United States
(12) Patent Application Publication
(10) Pub. No.: US 2015/0029022 A1
(43) Pub. Date: Jan. 29, 2015

(54) REMOTE ALERT MESSAGING DISPLAY AND CONFIRMATION

(71) Applicant: UTC FIRE & SECURITY AMERICAS CORPORATION, INC., Bradenton, FL (US)

(72) Inventor: Kevin Stebbins, Maplewood, MN (US)

(73) Assignee: UTC Fire & Security Americas Corporation, Inc., Bradenton, FL (US)

(21) Appl. No.: 14/384,527

(22) PCT Filed: Apr. 3, 2013
(86) PCT No.: PCT/US2013/035143

§ 371 Date: Sep. 11, 2014

Related U.S. Application Data
(60) Provisional application No. 61/620,109, filed on Apr. 4, 2012.

(51) Int. Cl. G08B 25/00

(52) U.S. Cl. CPC G08B 25/00
USPC 340/517

(57) ABSTRACT

In some aspects of the present application, a security device is disclosed that is operable to communicate with one or more on-premise sensors and one or more off-premise sensors/event generators. The device can comprise a control module that can comprise one or more receiving modules operable to receive one or more signals from one or more on-premise sensors and one or more signals from one or more off-premise sensors/event generators; a processor coupled with a memory module having stored therein computer-readable instructions operable to cause the processor to analyze the one or more signals from the one or more on-premise sensors and the one or more signals from the one or more off-premise sensors/event generators to determine whether to cause an audio, a visual or both an audio and visual alarm to be initiated; and a user Interface, coupled with the processor, operable to receive user input and display information indicative of the alarm.

### DESCRIPTION OF THE DISCLOSURE

1. Field of the Disclosure

The present application is directed to security systems, and more particularly to a method and apparatus for remote alert messaging display and confirmation using on-premise and off-premise sensors /event generators.

2. Background of the Disclosure

Conventional security systems, such as those arranged to protect a premise, use one or more on-premise sensors located strategically around and within the premise. For example, a home security system can include a command module located near an entrance to the home and one or more on-premise sensors, such as intruder alert sensors located near various entrance points of the home that can be triggered based on events around the perimeter of the home, as well as other sensors, such as smoke sensors that can be triggered based on events within the home. Upon a triggering event, the occupants of the home, as well, as other appropriate individuals (fire, police, and security system personnel) can be alerted via an alarm to a possible security event or breach. However, conventional security systems are not arranged to provide other alerts, alarms, or notifications to the occupants of the home of events or circumstances occurring outside of the home that are beyond the range of the on-premise sensors. What is needed is an improved security systems that overcomes problems of the conventional systems.

### SUMMARY OF THE DISCLOSURE

In accordance with some aspects of the present disclosure, a security device is disclosed that is operable to communicate with one or more on-premise sensors and one or more off-premise sensors. The device can comprise a control module that can comprise one or more receiving modules operable to receive one or more signals from one or more on-premise sensors and one or more signals from one or more off-premise sensors/event generators; a processor coupled with a memory module having stored therein computer-readable instructions operable to cause the processor to analyze the one or more signals from the one or more on-premise sensors/event generators and the one or more signals from the one or more off-premise sensors/event generators to determine whether to cause an audio, a visual or both an audio and visual alarm to be initiated; and a user interface, coupled with the processor, operable to receive user input and display information indicative of the alarm.

In some aspects, the one or more signals from the one or more on-premise sensors can comprise information from one or more active sensors, one or more passive sensors, or both one or more active and one or more passive sensors.

In some aspects, the one or more signals from the one or more off-premise sensors/event generators can comprise information received from one or more remote data processing and/or receiving modules.

In some aspects, the one or more signals from the one or more off-premise sensors/event generators can comprises information selected from the group consisting of: information related to national, regional, and/or local weather conditions, information related to natural disasters and/or terrorism, information related to missing, lost, and/or persons.

In some aspects, the device can comprise a transmitting module operable to transmit the information indicative to the alarms over one or more wired and/or wireless technologies to a mobile communication device.

In some aspects, the transmitting module can be operable to transmit one or more text messages to the mobile communication device.

In accordance with some aspects of the present disclosure, a method for communicating with one or more on-premise sensors and one or more off-premise sensors/event generators using a security device comprising a control module is disclosed. The method can comprise receiving one or more signals from one or more on-premise sensors and one or more signals from one or more off-premise sensors/event generators by a receiving module; analyzing, with a processor, the one or more signals from the one or more on-premise sensors and the one or more signals from the one or more off-premise sensors/event generators; determining whether to cause an audio, a visual or both an audio and visual alarm to be initiated; and displaying, with a user interface, information indicative of the alarm.

In some aspects, the one or more signals from the one or more on-premise sensors can comprise information from one or more active sensors, one or more passive sensors, or both one or more active and one or more passive sensors.

In some aspects, the one or more signals from the one or more off-premise sensors/event generators can comprise information received from one or more remote data processing and/or receiving modules.

In some aspects, the one or more signals from the one or more off-premise sensors/event generators can comprises information selected from the group consisting of information related to national, regional, and/or local weather conditions, information related to natural disasters and/or terrorism, information related to missing, lost, and/or persons.

In some aspects, the information indicative to the alarms can be transmitted over one or more wired and/or wireless technologies to a mobile communication device.

In some aspects, the method can comprise transmitting the information as a text message to the mobile communication device.

Additional embodiments and advantages of the disclosure will be set forth in part in the description which follows, and can be learned by practice of the disclosure. The embodiments and advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate several embodiments of the disclosure and, together with the description, serve to explain the principles of the disclosure.

### BRIEF DESCRIPTION OF THE DRAWINGS

FIG. 1 shows an example of a conventional security system with on-premises sensors.

FIG. 2 shows an example of a security system with on-premises and external sensors/event generators in accordance with aspects of the present disclosure.

FIG. 3 shows an example flow chart of the method for communicating with one or more on-premise sensors and one or more off-premise sensors/event generators using a security device comprising a control module in accordance with aspects of the present disclosure.

### DESCRIPTION OF THE EMBODIMENTS

Reference will now be made in detail to various exemplary embodiments of the present application, examples of which are illustrated in the accompanying drawings. Wherever possible, the same reference numbers will be used throughout the drawings to refer to the same or like parts.

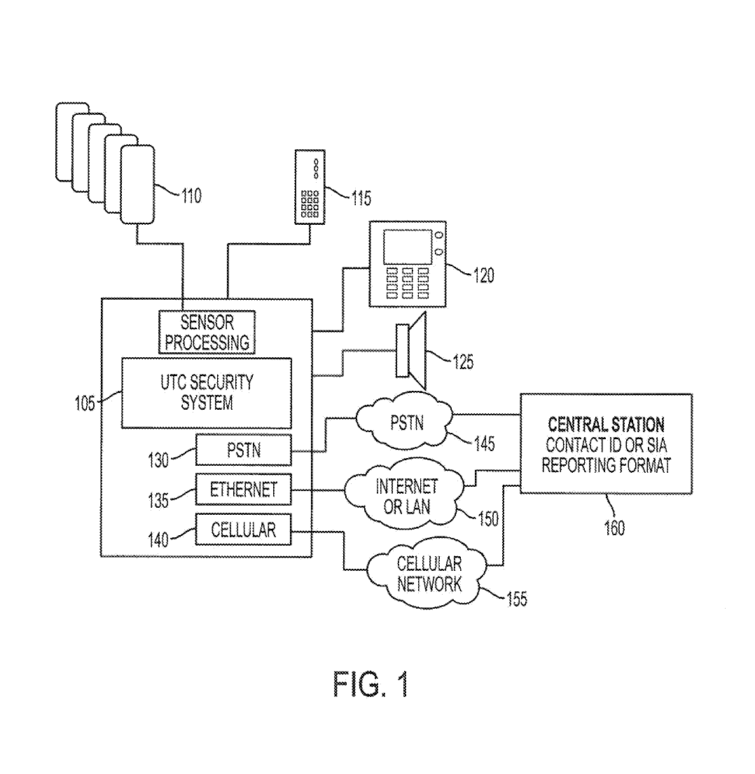

FIG. 1 shows an example of a security system with on-premises sensors. As shown, a security system can include a control module 105 connected to or coupled with one or more premises sensors 110. The one or more premises sensors 110 can be of a single sensor type or can include different types of sensors that can be operable to detect or sense one or more types of conditions or events. For example, sensors can include smoke and/or fire sensors, proximity alert sensors, carbon monoxide sensors, intruder alert sensors. The sensors can also operable with other devices such as, video camera systems, laser systems, and/or audio systems. Sensors can be positioned throughout the interior and/or exterior of a premise, such as a home, garage, office building, and surrounding areas. Sensors can be operable to send and/or receive signals from the control module 105.

Control module 105 can be arranged to include hardware/software/logic 115 to send and/or receive signals to/from the sensors 110 to control the sensors 110, as well as, interpret those signals. Control module 105 can be connected to or coupled with a keypad 115 and/or display with a keypad 120, which provide an interface with which a user can interact with the control module 105. Keypad 115 and display with a keypad 120 can be operable to allow the user to control, including activating and/or deactivating one or more, including all, of the sensors, or set preference when the system, including the sensors, are to be active or de-active. The display with a keypad 120 can allow the user a display screen, including physical or soft keys, with which to interact with the control module 105. The display portion of the display with keypad 120 can be operable to display information relevant to the user, such as alarm messages or on-premises generated messages. One or more speakers 125 can be connected to or coupled with control module 105 to provide one or more audio alerts, such as a siren, which can indicate to the user that the control module 105 has determined an event as occurred within the security system to which the user should be alerted. The audio alerts can be configured to be different depending on the type of activity which triggered the alert.

Control module 105 can be operable to communicate using one or more wired and/or wireless communication technologies or networks, for example, PSTN 130, Ethernet 135, and/or cellular 140 via a PSTN network 145, an Internet or LAN network 150, and/or a cellular network 155, respectively, to a central station 160. Central station 160 can be a localized in one location or can be distributed in multiple locations connected via one or more communication networks. Module 105 can provide data to the central station 160 in a format suitable for processing, such as a security industry association (SIA) reporting format.

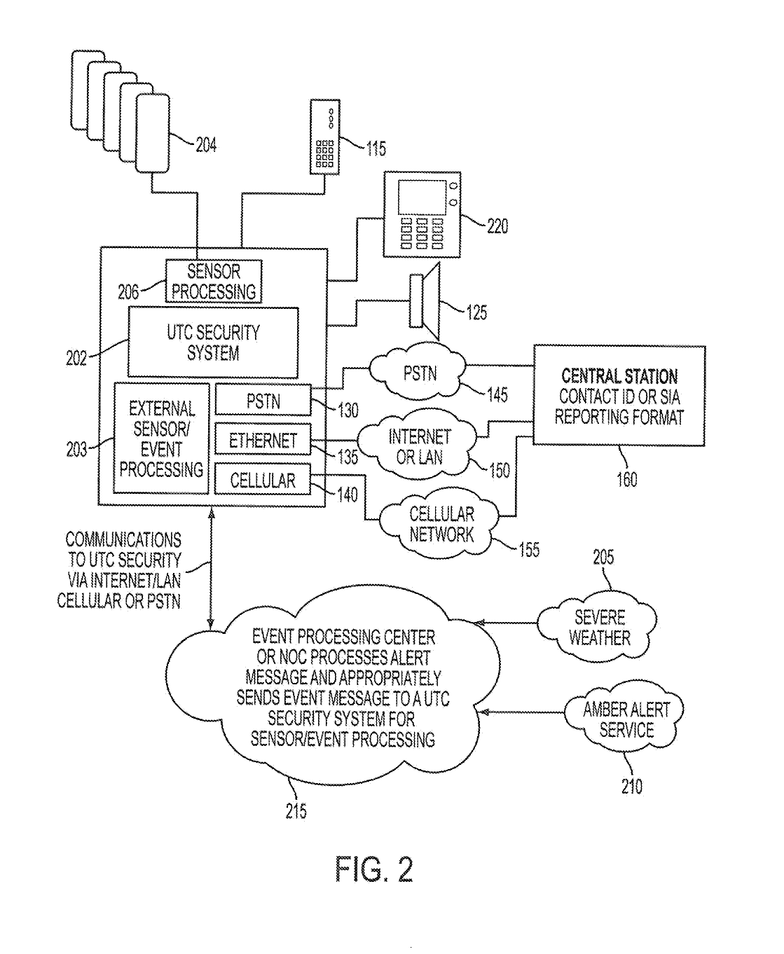

FIG. 2 shows an example of a security system with on-premises and external sensors in accordance with aspects of the present disclosure. FIG. 2 is similar to FIG. 1, with the addition of at least the control module 202 operable to interact with one or more event generators/external sensors 204 through a sensor control module 206. The sensors can be passive, omni-directional sensors; passive, narrow-beam sensors; and active sensors, among other types. Passive sensors can sense the data without actually manipulating the environment by active probing and are typically self powered; that is, energy is needed only to amplify their analog signal. Active sensors can actively probe the environment and can require continuous energy from a power source. Narrow-beam sensors can have a well-defined notion of direction of measurement, similar to a camera. Omni-directional sensors can have no notion of direction involved in their measurements.

One or more event data stores, such as a severe weather store 205 and an Amber alert service store 210 can be operable to provide up-to-date and/or periodic data updates to one or more event processing centers 215. Additionally and/or alternatively other important regional or local news or events, including weather, health, terrorism, and natural disaster-related events can be provided to the one or more event data stores or to the event processing center to be disseminated to control module 202. The one or more event processing centers 215 can receive the data updates from the one or more event data stores and send appropriately formatted messages to an external sensor/event processing module 203 connected to, coupled with, or integrated with the control module 202 for processing and alerting to the user. The event processing center 215 and/or the control module 202 can determine whether or not a particular event or notification is to be processed or displayed by the control module 202. For example, if a particular event or notification is only relevant to a particular region, only those control modules within that region would process or display the message or alarm. The alerts or notifications processed by the control module 202 from data originating from outside the premise can be displayed on the display 220 on the control module 202 and/or alerted to the user through the siren/speaker 125. By way of another example, an amber alert service 210 in combination with the event processing center 215 can be operable to generate an event (event generator) that can be sent to the panel's external sensor/event processing module 203. The event can be converted to the panel's native sensor format, which can then be sent to the panel alarm processing 202.

In some aspects, the control module 202 can be operable to communicate with other devices, computers, and/or appliances within the premise through one or more networks. For example, the control module 202 can be operable to connect to the user's computer or television via a wired or wireless network and be operable to send alerts and/or notifications to the user's devices to be displayed. This would allow the user the opportunity to view or hear important notifications and/or alerts when not near the control module 202.

In some aspects, the control module 202 can be operable to send messages, for example, text messages to a user's phone or communication device indicative of the type or content of the alert. For example, when the user is not within or near the premise having the control module 202, the user can still receive the notification and/or alert through the phone or communication device via a text message or similar messaging mechanism.

The externally generated events can be assigned a group and the panel can follow similar group processing rules as on-premises sensors, as shown in Table 1.

TABLE 1
Group Processing Rules

| | | | | | | Active in |
|---|---|---|---|---|---|---|
| | | | | | | arming |
| Type | Name/application | Siren type | Delay | Restoral | Supervised | levels |
| 00 | Fixed panic: 24-hour audible fixed emergency | Intrusion | I | N | Y | 1234 |
| | button. | | | | | |
| 01 | Portable panic: 24-hour audible portable | Intrusion | I | N | N | 1234 |
| | emergency button. | | | | | |
| 02 | Fixed panic: 24-hour silent fixed emergency | Silent | I | N | Y | 1234 |
| | button. Status light will not blink. | | | | | |
| 03 | Portable panic: 24-hour silent portable | Silent | I | N | N | 1234 |
| | emergency buttons. Status light will not blink. | | | | | |
| 04 | Fixed auxiliary: 24-hour auxiliary sensor. | Emergency | I | N | Y | 1234 |
| 05 | Fixed auxiliary: 24-hour emergency button. | Emergency | I | N | Y | 1234 |
| | Siren shut off confirms CS report. | | | | | |
| 06 | Portable auxiliary: 24-hour portable auxiliary | Emergency | I | N | N | 1234 |
| | alert button. | | | | | |
| 07 | Portable auxiliary 24-hour portable auxiliary | Emergency | I | N | N | 1234 |
| | button. Siren shut off confirms CS report. | | | | | |
| 08 | Special intrusion: Such as gun cabinets and wall | Intrusion | I | Y | Y | 1234 |
| | safes. | | | | | |
| 09 | Special intrusion: Such as gun cabinets and wall | Intrusion | S | Y | Y | 1234 |
| | safes. | | | | | |
| 10 | Entry/exit delay: A delay that requires a | Intrusion | S | Y | Y | 24 |
| | standard delay time. Chime. | | | | | |
| 13 | Instant perimeter: Exterior doors and windows. | Intrusion | I | Y | Y | 24 |
| | Chime. | | | | | |
| 14 | Instant interior: Interior door. | Intrusion | F | Y | Y | 234 |
| 15 | Instant interior: Interior PIR motion sensor. | Intrusion | F | Y | Y | 234 |
| 16 | Instant interior: Interior door. | Intrusion | F | Y | Y | 34 |
| 17 | Instant interior: PIR motion sensor and sound | Intrusion | F | N | Y | 34 |
| | sensor. | | | | | |
| 18 | Instant interior: Cross-zone PIR motion sensor. | Intrusion | F | N | Y | 34 |
| 19 | Delayed interior: Interior doors that initiate a | Intrusion | S | Y | Y | 34 |
| | delay before going into alarm. | | | | | |
| 20 | Delayed interior: PIR motion sensor that | Intrusion | S | N | Y | 34 |
| | initiates a delay before going into alarm. | | | | | |
| 21 | Local instant interior: 24-hour local alarm zone | Intrusion | I | Y | Y | 1234 |
| | protecting anything that opens and closes. No | | | | | |
| | report. | | | | | |
| 22 | Local delayed interior: Same as group 21, plus | Intrusion | S | Y | Y | 1234 |
| | activation initiates a delay before going into | | | | | |
| | alarm. No report. | | | | | |
| 23 | Local instant auxiliary: 24-hour local alarm zone | Emergency | I | Y | Y | 1234 |
| | protecting anything that opens and closes. No | | | | | |
| | report. | | | | | |
| 24 | Local instant auxiliary: 24-hour local alarm zone | Emergency | I | Y | Y | 1234 |
| | protecting anything that opens and closes. | | | | | |
| | Sirens shut off at restoral. No report. | | | | | |
| 25 | Local special chime: Notify the user when a | Three | I | N | Y | 1234 |
| | door is opened. | beeps | | | | |
| 26 | Fire: 24-hour fire, rate-of-rise heat, and smoke | Fire | I | Y | Y | 1234 |
| | sensor. | | | | | |
| 27 | Lamp control or other customer feature. No | Silent | I | Y | Y | 1234 |
| | report. | | | | | |
| 28 | PIR motion sensor, sound sensor, or pressure | Silent | I | N | Y | 1234 |
| | mat. RF thermostat. No report | | | | | |
| 29 | Auxiliary: Freeze sensor. | Trouble | I | Y | Y | 1234 |
| | | beeps | | | | |
| 32 | PIR motion sensor or sound sensor. No report. | Silent | I | N | N | 1234 |
| 34 | Carbon monoxide alarm. | Emergency | I | Y | Y | 1234 |
| 35 | Entry/exit delay interior PIR motion | Intrusion | S | N | Y | 234 |
| 36 | Special intrusion: Such as gun cabinets and wall | Intrusion | I | Y | Y | 1234 |
| | safes. Reports as tamper if tripped. | | | | | |
| 38 | Auxiliary: Water sensor. | Trouble | I | Y | Y | 1234 |
| | | beeps | | | | |
| 39 | Local instant interior: 24-hour local alarm zone | Intrusion | I | Y | N | 1234 |
| | protecting anything that opens and closes. No | | | | | |
| | report. | | | | | |
| 40 | Local special chime. | Three | I | Y | Y | 1234 |
| | | beeps | | | | |
| 43 | Property/asset management: Notify the user | One beep | I | N | Y | 1234 |
| | that a protected asset has moved. | | | | | |
| | Note: We recommend you use this sensor | | | | | |
| | group in combination with a Two-Way Talking | | | | | |
| | Touch Screen. | | | | | |

In Table 1, the delay can have different setting. For example, a delay of I or instant indicates that the alarm will sound instantly upon detection of an event. Examples of sensors that could use this delay setting include motion sensors. A delay of S or standard

S indicates that the alarm will sound after a predefined delay period. A delay of F or follower indicates that the alarm will sound after a predefined time interval unless a deactivation code is entered in the control panel.

Further with regard to Table 1, a level 1 active arming level indicates that the sensor is off. A level 2 is a STAY state, which provides the user the freedom is move around without setting off an alarm by bypassing interior devices, while maintaining the functioning of external sensors or those associated with doors or windows. A level 3 is an AWAY state, where the user is not home and all motion sensors are active. A level 4 is an AWAY state, where the user in not home and all sensors are active.

For example, a sensor assigned to type 10 of Table 1 and the following properties and settings. The sensor of this type is active when the panel is armed to levels 2 or 4 (stay and away), sounds intrusion siren cadence when sensor is activated, is supervised, is a delayed, and transmits restorals.

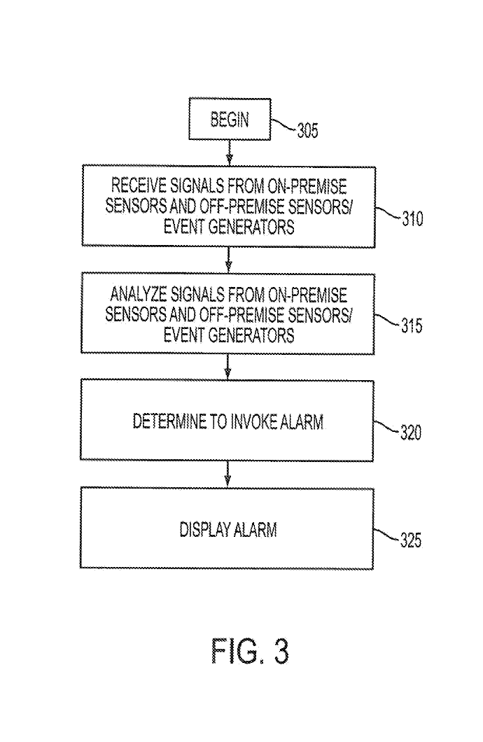

FIG. 3 shows an example flow chart of the method for communicating with one or more on-premise sensors and one or more off-premise sensors using a security device comprising a control module in accordance with aspects of the present disclosure. The process begins at 305. At 310, one or more signals from one or more on-premise sensors and one or more signals from one or more off-premise sensors/event generators can be received by a receiving module. At 315, a processor can analyze the one or more signals from the one or more on-premise sensors and the one or more signals from the one or more off-premise sensors/event generators. At 320, the processor or another processor can determine whether to cause an audio, a visual or both an audio and visual alarm to be initiated. At 325, information indicative of the alarm can be displayed on a user interface.

The control module can be arranged to operate using a variety of wireless communication systems to provide various telecommunication services such as telephony, video, data, messaging, and broadcasts. The wireless communication systems can include multiple-access technologies, which are capable of supporting communication with multiple users by sharing available system resources (e.g., bandwidth, transmit power). Examples of multiple-access technologies include code division multiple access (CDMA) systems, time division multiple access (TDMA) systems, frequency division multiple access (FDMA) systems, orthogonal frequency division multiple access (OFDIVIA) systems, single-carrier frequency divisional multiple access (SC-FDMA) systems, time division synchronous code division multiple access (TD-SCDMA) systems, worldwide interoperability for microwave access (WiMAX), and Long Term Evolution (LTE).

As used herein, the terms “networks” and “systems” are often utilized interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, 15-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM.RTEVI., etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP), CDMA2000 is described in documents from an organization named “3rd Generation Partnership Project 2” (3GPP2). These various radio technologies and standards are known in the art. Moreover, the networks and systems can include physical networks, virtual networks, cloud networks, clusters, sub-nets, partitions, etc. For example, data transmitted by device can be arranged to be transmitted on a primary or one or more auxiliary data channels through one or more cloud networks.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. Thus, for example, reference to “an acid” includes two or more different acids. As used herein, the term “include” and its grammatical variants are intended to be non-limiting, such that recitation of items in a list is not to the exclusion of other like items that can be substituted or added to the listed items.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

What is claimed is:

1. A security device operable to communicate with one or more on-premise sensors and one or more off-premise sensors and/or event generators, the device comprising:
a control module comprising:
one or more receiving modules operable to receive one or more signals from one or more on-premise sensors and one or more signals from one or more off-premise sensors and/or event generators;
a processor coupled with a memory module having stored therein computer-readable instructions operable to cause the processor to analyze the one or more signals from the one or more on-premise sensors and the one or more signals from the one or more off-premise sensors and/or event generators to determine whether to cause an audio, a visual or both an audio and visual alarm to be initiated; and
a user interface, coupled with the processor, operable to receive user input and
display information indicative of the alarm.

2. The device according to claim 1, wherein the one or more signals from the one or more on-premise sensors comprise information from one or more active sensors, one or more passive sensors, or both one or more active and one or more passive sensors.

3. The device according to claim 1, wherein the one or more signals from the one or more off-premise sensors and/or event generators comprise information received from one or more remote data processing and/or receiving modules.

4. The device according to claim 3, wherein the one or more signals from the one or more off-premise sensors and/or event generators comprises information selected from the group consisting of: information related to national, regional, and/or local weather conditions, information related to natural disasters and/or terrorism, information related to missing, lost, and/or persons.

5. The device according to claim 1, further comprising a transmitting module operable to transmit the information indicative to the alarms over one or more wired and/or wireless technologies to a mobile communication device.

6. The device according to claim 5, wherein the transmitting module is operable to transmit one or more text messages to the mobile communication device.

7. A method for communicating with one or more on-premise sensors and one or more off-premise sensors and/or event generators using a security device comprising a control module, the method comprising:
receiving one or more signals from one or more on-premise sensors and one or
more signals from one or more off-premise sensor and/or event generators by a receiving module;
analyzing, with a processor, the one or more signals from the one or more on-premise sensors and the one or more signals from the one or more off-premise sensors and/or event generators;
determining whether to cause an audio, a visual or both an audio and visual alarm to be initiated; and
displaying, with a user interface, information indicative of the alarm.

8. The method according to claim 7, wherein the one or more signals from the one or more on-premise sensors comprise information from one or more active sensors, one or more passive sensors, or both one or more active and one or more passive sensors.

9. The method according to claim 7, wherein the one or more signals from the one or more off-premise sensors and/or event generators comprise information received from one or more remote data processing and/or receiving modules.

10. The method according to claim 9, wherein the one or more signals from the one or more off-premise sensors and/or event generators comprises information selected from the group consisting of information related to national, regional, and/or local weather conditions, information related to natural disasters and/or terrorism, information related to missing, lost, and/or persons.

11. The method according to claim 7, further comprising transmitting the information indicative of the alarms over one or more wired and/or wireless technologies to a mobile communication device.

12. The method according to claim 11, further comprising transmitting the information as a text message to the mobile communication device.
